(19) United States
(12) Patent Application Publication
(10) Pub. No.: US 2007/0192518 A1
(43) Pub. Date: Aug. 16, 2007

(54) Apparatus for performing I/O sharing & virtualization

(75) Inventors: Sriram Rupanagunta, Bangalore (IN); Chaitanya Tumuluri, Santa Clara County, CA (US); Taufik Tuan Ma, Washington County, OR (US); Amar Ajit Kapadia, Santa Clara County, CA (US); Rangaraj Bakthavathsalam, Bangalore (IN)

Correspondence Address: J. Davis Gilmer, Esq., 1185B Minnesota, San Jose, CA, 95125, US

(73) Assignee: Aarohi Communications, Inc., a California Corporation

(21) Appl. No.: 11/353,698

(22) Filed: Feb. 14, 2006

(51) Int. Cl. G06F 13/38

(52) U.S. Cl. 710/62

(57) ABSTRACT

An apparatus is envisioned that manages I/O access for host subsystems that share I/O peripherals. Host subsystem ports receive I/O requests from and communicate with the plurality of platforms. A translation circuit, coupled to the host subsystem ports, identifies an I/O request from the host subsystem port as being associated with a particular host subsystem. A plurality of output ports are provided and are coupled to the peripheral I/O devices. A switching element is coupled to the translation circuit and to the output ports, and routes I/O requests to a particular output port. An operations circuit, coupled to the switching element, performs translation and redirection functions on the I/O requests. A management circuit interfaces with the host subsystems. The management circuit manages the use of the output ports and brokers the physical usage of the ports. The apparatus is contained on physical devices distinct from the plurality of platforms.

### FIELD OF THE INVENTION

The present invention relates generally to the field of computer architecture and, more specifically, to methods and systems for managing resources among multiple operating system images within a logically partitioned data processing system, or amongst differing computer systems sharing input/output (I/O) devices.

### DESCRIPTION OF THE ART

In some computerized systems, it may be necessary or advantageous to share resources, such as memory, storage, interconnection media, and access to them. In particular, the modern networking milieu (exemplified by IT and Data Center operations) has produced an environment that rewards efficient sharing of these resources. As an example, a common data center may have such functional units as a front-end network server, a database server, a storage server, and/or an e-mail server. These systems (or for that matter, hardware or software subsystems within a single system) may need to share access to slower or faster storage, networking facilities, or any other peripheral functions. These peripheral items can generally be identified as input/output (I/O) subsystems.

In order to gain efficiencies in each physical system, a concept of logical partitioning arose. These logical partitions separate a single physical server into two or more virtual servers, with each virtual server able to run independent applications or workloads. Each logical partition acts as an independent virtual server, and can share the memory, processors, disks, and other I/O functions of the physical server system with other logical partitions. A logical partitioning functionality within a physical data processing system (hereinafter also referred to as a “platform”) allows multiple copies of a single operating system (OS) or multiple heterogeneous operating systems to be simultaneously run on the single platform. Each logical partition runs its own copy of the operating system (an OS image) which is isolated from any activity in other partitions.

In order to allow each of the major functional units as embodied in the various partitions (and/or their subsystems) to access or use the various I/O capabilities, an idea that a centralized module be used to manage them was developed. The act of creating and managing the partitions, as well as coordinating and managing the I/O functions of the partitions, was delegated to this module which acted as a buffer between the logical partitions and the specific I/O peripherals associated with the platform or system. The logical partitioning functionality (and associated management of the I/O) can typically be embodied in such systems by software, referred to generally as “Hypervisors”. Correspondingly, the term “hypervised” systems can be used to indicate such systems using hypervisor software to perform such management functions.

Typically, a logical partition running a unique OS image is assigned a largely non-overlapping sub-set of the platform's resources. Each OS image only accesses and controls its distinct set of allocated resources within the platform and cannot access or control resources allocated to other images. These platform allocable resources can include one or more architecturally distinct processors with their interrupt management area, regions of system memory, and I/O peripheral subsystems.

In the logical partitions, the operating system images run within the same physical memory map, but are protected from each other by special address access control mechanisms in the hardware, and special firmware added to support the operating system. Thus, software errors in a specific OS image's allocated resources do not typically affect the resources allocated to any other image.

The allocation functionality arbitrating the grant of, the control over, and access to allocable resources by multiple OS images is also done by the “hypervisors”. Typically, in such hypervised systems, the device driver in the OS image is loaded with a virtual device driver. This, virtual device driver takes control of all I/O interactions, and redirects them to the hypervisor software. The hypervisor software in turn interfaces with the I/O device to perform the I/O function.

FIG. 1 is an exemplary embodiment of a conventional hypervisor system. The setup includes partitioned hardware, possibly having a plurality of processors, one or more system memory units, and one or more input/output (I/O) adapters (possibly including storage unit(s)). Each of the processors, memory units, and I/O adapters (IOA) may be assigned to one of multiple partitions within the logically partitioned platform, each of the partitions running a single operating system. It should be noted that the Figure as depicted denotes the networking functionality of the hypervisor system, and it should be understood that any associated logical partitions or virtual devices may have virtual connection for any number of I/O functions (e.g. storage connections using host bus adapters (HBAs), among many others.)

The software hypervisor layer facilitates and mediates the use of the I/O adapters by drivers in the partitions of the logically partitioned platform. For example, I/O operations typically involve access to system memory allocated to logical partitions. The coordinates specifying such memories in I/O requests from different partitions must be translated into a platform-wide consistent view of memory accompanying the I/O requests reaching the IOA. Such a translation (and effectively protection) service is rendered by the hypervisor and will have to be performed for each and every I/O request emanating from all the logical partitions in the platform.

Thus, the I/O requests are necessarily routed through the hypervisor layer. Being software, this of course potentially adds large amounts of overhead in providing the translation and other such mediation functions, since the hypervisor runs on a computing platform, and that platform may also run one or more of the OS images concurrently. Accordingly, running the I/O requests through the software or firmware hypervisor layer adds extraneous overhead due to the nature of the solution, and can induce performance bottlenecks.

As alluded to previously, the modern data center has seen a proliferation of independent or standalone platforms (hypervised or otherwise) dedicated to the performance of one or perhaps multiple functions. Such functions include such devices as web-server front-end systems, back-end database systems, and email server systems, among a plethora of other functional units or systems that can populate a modern data center. Each such platform has a dedicated eco-system (typically) of I/O subsystems which include storage devices, network devices and both storage and networking input/output adapters (IOAs). Additionally, each platform may well have storage and network communication fabrics connecting them to other such dedicated platforms and their resources.

In this vein, a data center administrator in such an installation would be faced with the task of provisioning of the I/O subsystem resources for each dedicated server platform. The coupled nature of the relationship between a centralized management layer, the intricacies of the physical elements necessary for the operation of each functional unit, and the possibility of conflicts between the units and/or the management layer lead to complexities in the management of them. Accordingly, the efficient operation of such systems can be taxing at best. Needless to say, finding an optimal solution (i.e. one that addresses any resulting over-provisioning or the under-utilization of any dedicated I/O peripheral subsystem resources) would be even harder to achieve.

Another issue faced by the administrators is the ever-expanding footprints of such proliferating functionally-focused platforms in the data centers. Accordingly, the IT industry is evolving towards the use of so-called “blade servers” to address this issue of spatial dimensions.

Blade servers are typically made up of a chassis that houses a set of modular, hot-swappable, and/or independent servers or blades. Each blade is essentially an independent server on a motherboard, equipped with one or more processors, memories and other hardware running its own operating system and application software. The I/O peripheral subsystem devices, to the extent possible, are shared across the blades in the chassis. Note that the notion of sharing in this environment is almost an exact equivalent, conceptually, to the notion of sharing resources via virtualization in a hypervised platform. Individual blades are typically plugged into the mid-plane or backplane of the chassis to access shared components. The resource sharing of blades provides substantial efficiencies in power consumption, space utilization, and cable management compared to standard rack servers.

In this manner, the use of blade servers can achieve economies of cost, complexity, and scale by sharing the I/O subsystem resources mentioned earlier. In current blade systems, each blade contains a peripheral component subsystem that communicates with the external environment. In this context, a management entity (analogous to the Hypervisor in the earlier logically partitioned systems) typically provisions the shared I/O peripheral subsystem resources among the blades, and also can provide translation and mediation services.

Attempting to mix a logically partitioned hypervised system with one or more stand-alone/independent system platforms (e.g., those found in blade servers) can lead to other serious issues for an administrator of such a data center. Since the I/O peripheral subsystem virtualization defines and manages allocable resources internal to the hypervised platforms, any attempt to extend the sharing of these I/O resources to other external independent platforms (hypervised, bladed, a combination of the two or even otherwise) will be extraordinarily complicated.

However, the administrator may be faced with an amalgamation of hypervised systems and independent or standalone systems. In this case, enhancing I/O resources utilization can be effective in creating cost and/or space efficiencies in the modern data center ethos.

Hence, in any such data center milieu, the allocation, protection, migration, reclamation, and other management activities related to providing a virtualized and/or shared set of I/O peripheral subsystem resources is a significant burden. In the context of a multi-host subsystem arrangement, these functions are usually borne by the system in some manner. In a bladed environment, this may be borne by the blades themselves by one of the blades operating in a structured role. In a hypervised environment, the needs and requests of the logical partitions are serviced by a central processor which runs the hypervisor, and which typically runs some or all the OS images. Further, the inefficiencies inherent in the translation and mediation services performed on each I/O request as well add to burden of managing any of these centers.

### DESCRIPTION OF THE DRAWINGS

The accompanying drawings, which are incorporated into and constitute a part of this specification, illustrate one or more embodiments of the invention. Together with the explanation of the invention, they serve to detail and explain implementations and principles of the invention.

In the drawings:

FIG. 1 is an exemplary embodiment of a conventional hypervisor system.

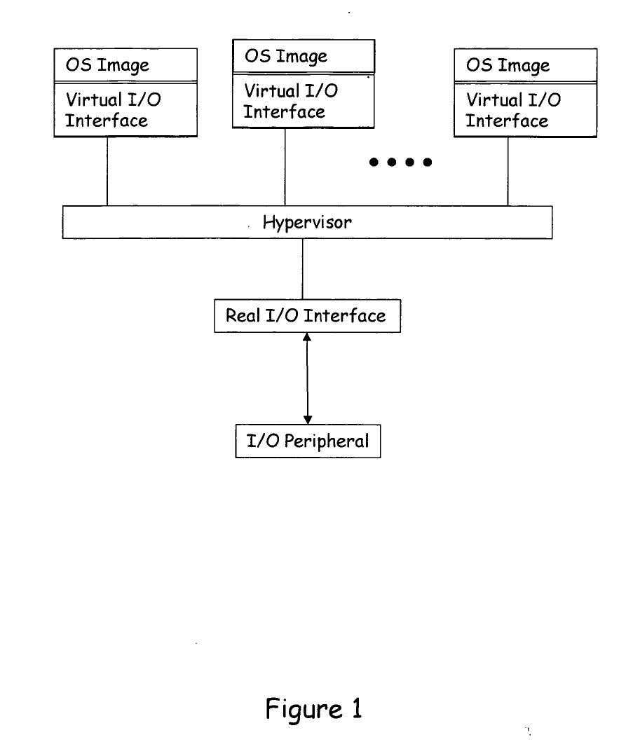

FIG. 2 is a schematic block diagram of an exemplary I/O sharing and virtualization (IOSV) processor.

FIGS. 3a-d are block diagrams detailing the potential use of the IOSV processor amongst various platforms.

FIG. 4 is a schematic diagram detailing a possible implementation of an IOSV processor in conjunction with FIGS. 2 and 3a-d.

### DETAILED DESCRIPTION

Embodiments of the present invention are described herein in the context of an apparatus of and methods associated with a hardware-based storage processor. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-, engineering-, and/or business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of integrated circuits. In addition, those of ordinary skill in the art will recognize that devices of a more general purpose nature, such as hardwired devices, field programmable gate arrays (FPGAs), application specific integrated circuits (ASICs), or the like, may also be used without departing from the scope and spirit of the inventive concepts disclosed herein.

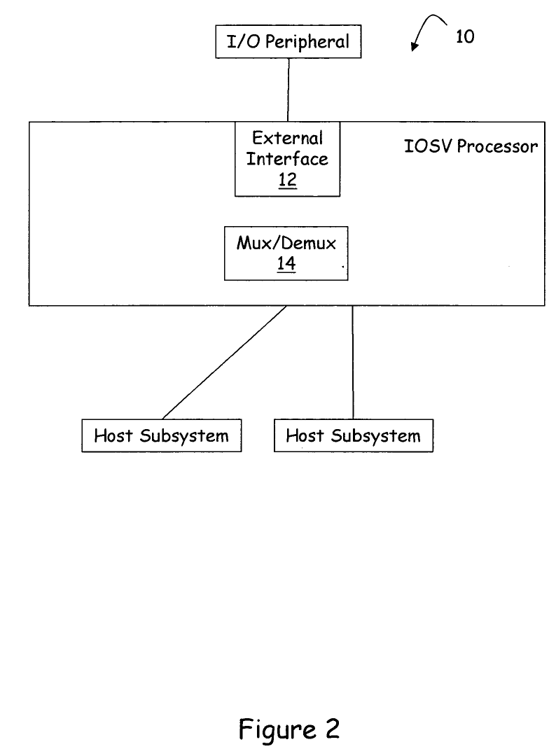

FIG. 2 is a schematic block diagram of an exemplary IOSV processor. An IOSV processor 10 is coupled to one or more platforms or host systems (i.e a blade server or hypervised server) that require or use separate I/O peripheral devices. The IOSV processor 10 has an external connection 12 that links the IOSV processor with an I/O peripheral. Although one external connection and one I/O peripheral is shown, any number may be implemented.

The IOSV processor 10 has a mux/demux circuit 14 which performs translation and mediation services on IO requests received from the various logical partitions or blades or similar associated with the host subsystem. This being the case, the mux/demux of the IO requests takes place at a point away from the host subsystems, thereby reclaiming processing cycles for the host subsystems. Additionally, such a relocation of the management, translation, and mediation services allows the IOSV processor to be used with stand-alone platforms (rack mount systems lacking I/O), hypervisors, multiple independent platforms within a chassis (i.e. blade servers), and any combination thereof. Accordingly, with this ability to mix the various types of systems, the depicted IOSV processor can be used to coordinate I/O requests for any number of physical platforms, virtual platforms, and any combination thereof.

Additionally, the IOSV processor can manage and allow for mux/demux functionality across the I/O request traffic seen from various physically disparate platforms over a shared peripheral interconnect medium. The functionality to dedicate, virtualize, and/or share the real physical ports of an IOSV processor among the hypervised, bladed, or standalone server platforms (or combinations thereof) can be implemented as part of an IOSV realization.

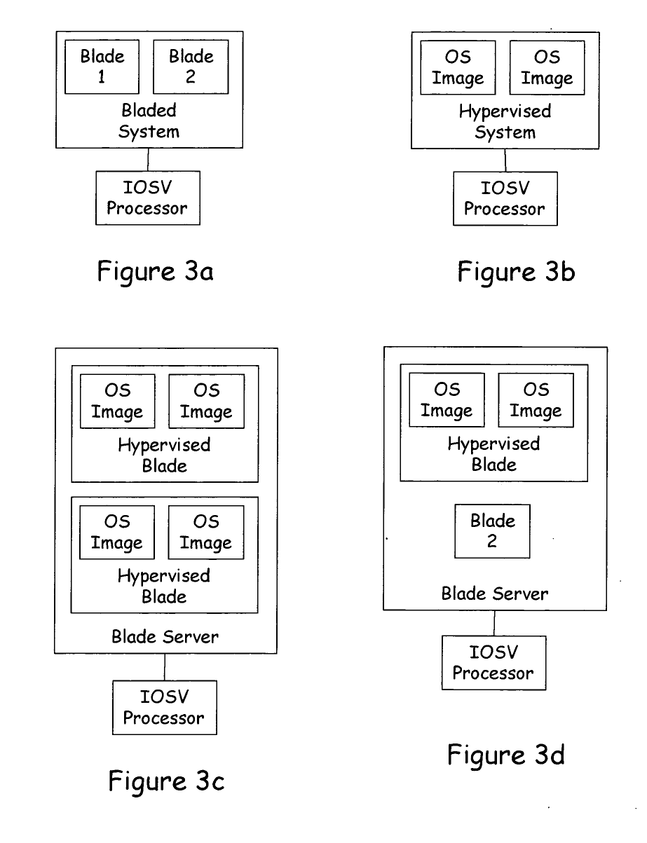

FIGS. 3a-d are block diagrams detailing the potential use of the dedicated IOSV processor amongst various platforms. The splitting and placing of the IO mux/demux and/or virtual I/O adapters allows a mix of platforms to be serviced with little or no overhead. FIG. 3a details the use of an IOSV processor operating with multiple independent single platforms operating in an environment requiring the sharing of physical I/O resources (e.g., blades in a bladed server). In this case, the IOSV processor manages the shared access to the physical I/O resources as well as the translation and mediation across their IO requests for them. FIG. 3b details the use of an IOSV processor operating with a hypervisor system, where the IO virtualization management, translation, and/or mediation details of the virtual machines can be managed by the IOSV processor. FIG. 3c details the use of an IOSV processor with multiple hypervisors within a common environment, such as a bladed system. The IOSV processor is configured to operate each of the virtual machines for each hypervised system within the common environment. FIG. 3d shows the use of an IOSV processor with a mixture of hypervisor and single independent platforms within a common environment (e.g., mixture of stand-alone blades and hypervised blades in a bladed server). These diagrams are exemplary in nature, and one should note that the use of the IOSV processor with an independent platform away from a hosted environment is also contemplated. It should also be noted that a common environment may include bladed systems, hypervised systems; or any combination thereof.

In one embodiment, the drivers in the logical partitions in a hypervised system can talk “directly” (i.e. without the mediation or translation services of any host subsystem entities such as a Hypervisor) to the virtual interfaces created, maintained, and/or exported by the IOSV processor. Also, the virtual interfaces can be implemented in hardware, but can be dynamically set-up and taken-down by a hypervisor, or a single independent platform operating in conjunction with the IOSV processor.

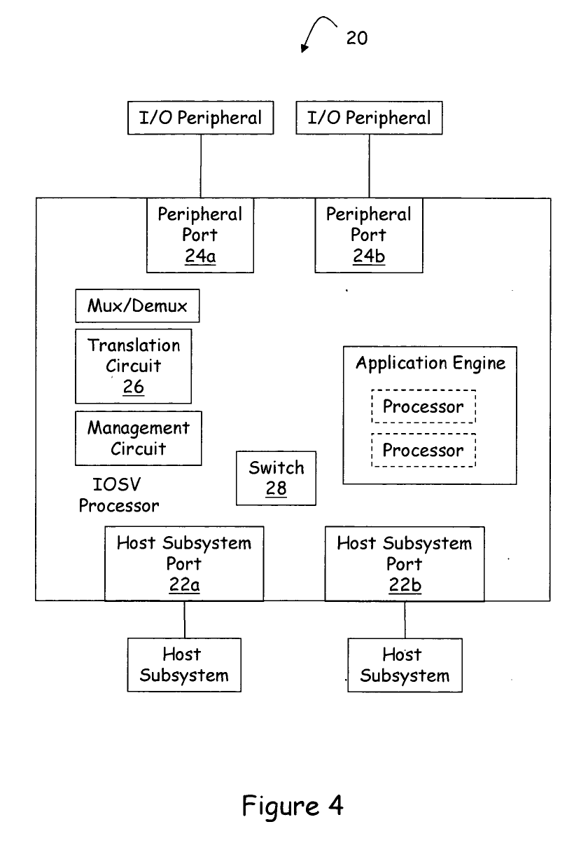

FIG. 4 is a schematic diagram detailing a possible implementation of an IOSV processor in conjunction with FIGS. 2 and 3a-d. In FIG. 4 an IOSV processor 20 has one or more host subsystem ports 22a-b. The ports can be used for bi-directional data flow with a host subsystem under a protocol.

The IOSV processor 20 also has one or more peripheral ports 24a-b. These peripheral ports allow communication between various I/O peripherals and the IOSV processor.

Such communication protocols employed by the IOSV processor may include SCSI over Fibre Channel (SCSI-FCP), SCSI over TCP/IP (iSCSI or Internet Small-computer-Systems Interface) commands directing specific device level storage requests. They may also involve any other higher level protocols (such as TCP/IP) running over Fibre Channel, Ethernet or other transports. Such protocols are exemplary in nature, and one skilled in the art will realize that other protocols could be utilized. It is also possible that there may be multiple layers of datagrams that may have to be parsed through to make a processing or a routing decision in the storage processor. Further, other networking protocols such as TCP/IP may be employed. One should note that numerous possibilities exist for such communications protocols and that these descriptions should be taken as illustrative in nature, and other types of protocols could be easily employed in the use of the current description. In addition to networking protocols, other bus protocols such as personal computer interface (PCI) or other direct link protocols may be employed with the IOSV processor.

A translation circuit 26 is also present in the IOSV processor. When an I/O request is received (either from a host subsystem port or an I/O peripheral port), the translation circuit can parse the request and associate the request with a particular host subsystem, a particular I/O peripheral, a particular host subsystem port, a particular output port, or any combination of the above. In this manner, the context of the incoming request (whether it is coming from a host subsystem port or an I/O peripheral port) can be noted and stored. Such contexts can be modified during the operation of the IOSV processor as the IOSV processor performs actions in response to that request or upon that request.

A switching circuit 28 is also present in the IOSV processor 20. In one instance, a buffer memory crossbar switch may be employed in this role. The switching circuit can be used to store both incoming and outgoing requests and/or data related to requests. The crossbar can also be used to route or switch the various requests to or from I/O peripheral ports, host subsystem connection ports, and/or elements of the IOSV processor that are capable of performing operations on or in light of the requests (e.g., the functions performed by any processing engines, described supra.)

If the specific implementation of the switch circuit is a memory buffer, this can be used in conjunction with the translation circuit in the IOSV processor. The crossbar switch can also used for additional storage for any tables or data used in the muxing/demuxing process, in the translation services, or used in bridging services between protocols. This storage could be temporary in nature, or longer term, depending upon the particular circumstances.

An application processing engine is coupled to the switching circuit. The processing engine can employ a plurality of processors, each operable to execute a particular task. These processors can be dynamically programmable or reprogrammable. Each of the processors could have an associated memory in which to store instructions relating to the task, or data associated with the task. The processor can be employed to perform data functions, such as translation of incoming requests from one protocol to another, or other tasks associated with the data, the protocol; or the tasks that have been requested. In this manner, low latency processing of I/O requests across multiple platforms (physical or logical) can be achieved, as well as detection, potential redirection, and repurposing of data flow. Such functions can be defined singularly or in combination, and such functions can be run in a serial or parallel fashion, as needs dictate.

A management circuit is also present in the IOSV processor. This management circuit can act as a director or coordinator of the I/O various requests received at or operated upon by the IOSV processor. The management circuit can also be used to manage the allocation of the host subsystem ports and/or the I/O peripheral ports, or to allocate and/or deallocate elements of the processing engine to perform various functions. Thus, access from multiple host subsystems can be managed at the IOSV, as well multiple peripherals. Further, the coordination of the various flows between the various combinations can be managed as well.

In this manner, host subsystems that require a sharing of I/O peripherals between them (i.e. hypervised systems, a collection of standalone blade servers in a bladed server system, or the use of hypervised blades in a blade server (with or without other hypervised blades and/or other standalone blades)) can share those I/O peripherals without adversely affecting the workload on any associated host subsystem or component of a host subsystem. The IOSV processor is a way that the burden on the host system to support such functionality can be eased.

FIG. 5 is a schematic block diagram detailing a potential manner of operation of an IOSV with a host subsystem having multiple operating systems sharing I/O peripherals. One of the associated host subsystems generates a request, and sends it to the host subsystem port. Once received at the host subsystem port, the translation circuit parses the request and develops a context for that request. Based upon the request, the translation circuit may perform certain functions on it, typically by directing it to one of the processors.

Depending upon the state of the request or the type of the request, the request may be directed to an I/O peripheral through a particular I/O peripheral port. Of course, this may or may not be after performing intermediate operations or functions on the request through the use of the processors.

Of course, more than one request may be directed to any particular I/O peripheral or any I/O peripheral port. In this context, the IOSV processor can queue an incoming or processed I/O request for such transmission. It should be noted that queue priorities are a function that could be performed by the IOSV processor as well.

Of course, the IOSV processor could maintain a status for an outgoing request after the request has been communicated to the proper port or I/O peripheral. In this manner, one of the functions of the IOSV processor could be a monitoring function as well. Upon a return from an I/O peripheral, similar functions as explained in the discussion about the receipt of a request from the host subsystem could be performed, allowing the IOSV processor to complete the transaction.

In another mode, the initiator of the request could be an I/O peripheral. Again, a similar methodology as explained above with regards to a host subsystem issuing the request could be employed.

In yet another mode, a request could originate from the IOSV processor itself. And, in yet another mode, a request could be made from either a host subsystem that terminates within the IOSV processor, or results in a return transmission from the IOSV processor without any other external transmissions being generated.

Of course, more than one I/O peripheral may share a port. Further, more than one port could be used to communicate with an I/O peripheral. The IOSV processor could be used to manage and maintain these interconnections as well.

In one embodiment, the IOSV can be configured to work with a specific type of environment. For example, for use with a hypervised system, the IOSV can be configured to present a specific interface to the hypervised subsystems that is consistent with the operation of the normal hypervised system. In this context, the IOSV can interface with the specific subsystems so that each subsystem is presented an environment that indicates that the subsystem has exclusive use of all or some of the ports and/or I/O peripherals. Of course, the hypervised subsystem could be presented an environment where the ports that it is aware or has knowledge of are, in fact, virtualized, as well as physical in nature.

In another use with a bladed system, the IOSV can be configured to present a specific interface to the individual subsystems that is consistent with the operation of the normal bladed system. In this context, the IOSV can interface with the specific subsystems so that each subsystem is presented an environment that indicates that the subsystem can transparently share the use of all or some of the ports and/or the I/O peripherals. Again, the bladed subsystem could be presented an environment where the ports that it is aware or has knowledge of are, in fact, virtualized, as well as physical in nature, as in the case of the hypervised subsystems described above.

In this manner, a dedicated hardware and processor system can be formulated to provide virtualization and shared IO services for a multitude of machines, both physical and logical. In this manner, if individual platforms share IO devices, the IOSV processor may serve as an arbiter and as a multiplexer/demultiplexer for those platforms.

In another aspect, one can operate a hypervisor platform more efficiently through the use of dedicated IOSV processing. In this case, the management of the I/O peripherals and the management of any associated I/O requests can be focused onto a dedicated IOSV device, thus easing the processing burden from the host subsystem in part or in full, as needs dictate.

In another aspect, multiple hypervisors can be managed by making use of IOSV processing. The I/O functionality of the hypervisors can be merged without massive changes to the hypervisors themselves. Thus, this not only saves effort and resources through the aggregation of virtual I/O functions, this eases complexity and costs inherent in host subsystem-based hypervisor management.

In yet another aspect, independent platforms and hypervisors can share I/O resources. This allows disparate platforms to be aggregated and gain efficiencies.

Finally, the presence of a device dedicated to processing I/O functions with the ability to manage the specific dataflows to and from the various I/O peripherals allows better management of those specific peripherals. Additionally, multiplex and demultiplex requests to and from the various physical ports allows the IOSV processor to manage the usage of the specific ports, thus culmination in more efficient use of the port(s). Finally, the multiplexing and demultiplexing allows for more than one physical port to service any specific I/O peripheral. Again, this leads to efficiencies in port management, as well as I/O peripheral management.

Accordingly, this allows a wide spectrum of platforms to be serviced and/or functions to be accommodated. This could potentially boost I/O performance by a considerable amount. In this case, since the IOSV processor performs the I/O management tasks, the host platforms are not tasked with these and the associated functions.

When the host subsystem “directly” accesses the virtual interfaces exported by the IOSV processor, the I/O data is potentially accessed or processed only at the IOSV processor (and not in any intermediate subsystem). The elimination of intermediary accesses means additional performance gains can be achieved. This is because the generation of multiple intermediate copies of the data (and the cost of translations among them) are avoided.

In context, in one embodiment of the IOSV processor, the following methodology could take place. The IOSV processor is operable to manage I/O requests, those I/O requests coming from any of a number of host subsystems. First, an I/O request is received from a first host subsystem. The IOSV processor determines which of the host subsystems this is from, and can operate on that request accordingly.

The IOSV processor next retrieves a context associated with the subsystem that generated the request. This context can be selectively updated. This can be Dependent upon the request, the history of requests, or based upon other things such as user redefinition, priorities, and/or new I/O subsystems or new host subsystems being introduced.

Based on a state of the target device, the IOSV can selectively queue the first I/O request in a list. The list can be specific to the context. Next an appropriate protocol associated with the I/O request is determined. Based on the request, the IOSV processor can perform one or more I/O operations on the I/O request.

The request can be sent to a remote I/O peripheral, where the data in the request is associated with a requested action. The request can be in an unaltered form, or it can be one that has been changed due to the I/O operations that may have been performed on it.

In most cases, a return I/O request from the remote I/O peripheral is received at the IOSV processor. The returned I/O request can. be either data associated with the sent I/O request, or the status from the peripheral device. The IOSV processor retrieves the context associated with the subsystem that generated the request. Again, the context could be selectively updated.

If the original request only targets one I/O device, the IOSV processor can dequeue the original incoming I/O request. Of course, the IOSV processor could make one I/O request to two I/O devices, and the dequeue of the request may wait until later.

Again, one or more operations may be performed on the return I/O request. The specific operations can be determined by the protocol associated with the I/O request. The results of the operations are then sent to the host subsystem.

Thus, an apparatus and method for an apparatus for performing I/O sharing and virtualization is described and illustrated. Those skilled in the art will recognize that many modifications and variations of the present invention are possible without departing from the invention. Of course, the various features depicted in each of the Figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the appended claims that follow.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims. Accordingly, we claim:

1. An apparatus for managing I/O access for a plurality of host subsystems, each host subsystem having associated I/O requests, each host subsystem having a sharing relationship with the other host subsystems relating to I/O requests, the apparatus comprising:
One or more host subsystem ports, operable to receive I/O requests from and communicate with the plurality of platforms;
A translation circuit, coupled to the one or more host subsystem ports, operable to identify an I/O request from the host subsystem port as being associated with a first host subsystem from among the plurality of host subsystems;
A plurality of output ports, each coupled to one or more I/O devices that perform I/O functions;
A switching element, coupled to the translation circuit and to the plurality of output ports, operable to route a first I/O request associated with the first host subsystem to a particular output port;
An operations circuit, coupled to the switching element, operable to perform translation and redirection functions on I/O requests;
A management circuit, coupled to the switching element, and operable to interface with each of the plurality of host subsystems;
Wherein the management circuit manages the use of the output ports on the request of the associated host subsystems and brokers the physical usage of the ports.
Wherein the apparatus is contained on physical devices distinct from the plurality of platforms.

2. A method of managing I/O requests associated with a plurality of host subsystems, the host subsystems operating in a common environment, the method operating in a device apart from the host subsystems, the method comprising:
Receiving a first I/O request associated with an I/O function from a first host subsystem from among the plurality of host subsystems;
Retrieving a context associated with the first subsystem;
Selectively, updating the context;
Selectively, based on a state of the device, queueing the first I/O request in a list that is specific to the context;
determining an appropriate protocol associated with the I/O request;
performing one or more I/O operations on the I/O request, the specific operations determined by protocol associated with the I/O request, the step of performing resulting in a second I/O request;
sending the second request to a remote I/O peripheral, the data in the second request associated with a requested action;
receiving, at the device, a return I/O request from the remote I/O peripheral, the return I/O request associated with the second I/O request;
retrieving the context associated with the first host subsystem;
selectively updating the context associated with the associated with the first host subsystem;
selectively dequeuing the first I/O request;
performing one or more operations on the return I/O request, the specific operations determined by the protocol associated with the I/O request, the step of performing resulting in a third I/O request;
sending to the first host subsystem the third I/O request.
